(19) United States
(12) Patent Application Publication
(10) Pub. No.: US 2023/0098399 A1
(43) Pub. Date: Mar. 30, 2023

(54) AIR CONDITIONER

(71) Applicant: LG Electronics Inc., Seoul (KR)

(72) Inventors: Youngheon KWON, Seoul (KR); Beomsoo SEO, Seoul (KR)

(21) Appl. No.: 17/796,144

(22) PCT Filed: Dec. 10, 2020
(86) PCT No.: PCT/KR2020/018042

§ 371 Date: Jul. 28, 2022

(30) Foreign Application Priority Data
Jan. 28, 2020 (KR) 10-2020-0010005

(51) Int. Cl. F24F 13/22; F24F 1/0063; F24F 11/89

(52) U.S. Cl. CPC F24F 13/222; F24F 1/0063; F24F 11/89; F24F 2013/227; G01F 23/30

(57) ABSTRACT

The air conditioner according to the present disclosure may comprise a heat exchanger exchanging heat between air and refrigerant, a fan discharging air toward the heat exchanger, a first drain pan disposed in a direction crossed to a direction of air flowing from the fan to the heat exchanger, wherein the first drain pan has an inlet opening through which air discharged from the fan flows toward the heat exchanger, a second drain pan disposed in a direction parallel to a direction of air flowing from the fan to the heat exchanger and a water level sensor rotatably disposed with reference to a rotating center spaced apart from the first drain pan and the second drain pan, wherein the water level sensor detects a water level of water gathered in one of the first drain pan and the second drain pan.

### TECHNICAL FIELD

The present disclosure relates to an air conditioner, and more particularly to an air conditioner provided with a water level sensor detecting a water level of a drain pan for containing condensate water generated by a heat exchanger.

### BACKGROUND ART

An air conditioner is a device exchanging heat between refrigerant flowing in an evaporator or a condenser and air so as to supply the air to indoor. Among air conditioners, a unitary type air conditioner connects an indoor space to a duct and supply air that had flowed through a heat exchanger and/or gas furnace to the indoor space.

Korean Patent Publication No. 10-2005-0041672 discloses a unitary type air conditioner provided with a rectangular frame and an a-coil having an end which is supported by an upper side of the rectangular frame. The a-coil includes a plurality of tubes allowing refrigerant to flow therein so as to supply heat-exchanged air to indoor.

Moisture contained in air during exchanging heats between air and refrigerant may be condensed, and then the condensate water may be gathered in a condensate water reservoir disposed at a lower side of the frame or the a-coil. The water gathered in the condensate water reservoir may be evaporated naturally or discharged through a drain pipe connected with the condensate water reservoir to outdoor.

Meanwhile, an indoor unit including the a-coil of the unitary type air conditioner generally is installed at a basement room or an attic, air-conditioned air is supplied to indoor space through the duct. Because the basement room or attic is prone to contamination, the drain pipe is prone to be blocked by contaminant Therefore, water gathered in the condensate water, or something cannot be discharged to outdoor, so the water can overflow from the condensate water reservoir. In addition, because the basement room or attic is not a space which many people get in and out frequently, it is difficult to recognize overflowing of the condensate water immediately.

In the mean time, an indoor unit installed in the basement room generally can be installed vertically so that air flowed from a lower side can pass through the heat exchanger while flowing upwardly. On the other hands, an indoor unit installed in the attic which is characterized in a low height in nature can be installed horizontally so that air can pass through the heat exchanger while flowing horizontally.

### DISCLOSURE

### Technical Problem

One object of the present disclosure is to provide an air conditioner capable of detecting a water level of water gathered in a drain pan after being condensed in a heat exchanger.

Another object of the present disclosure is to provide an air conditioner capable of detecting a water level of water gathered in the drain pan through one water level sensor without reinstalling the water level sensor, regardless of whether the indoor unit is installed in a first direction or a second direction which is perpendicular to the first direction.

Another object of the present disclosure is to provide an air conditioner capable of preventing condensate water generated in the heat exchanger from overflowing from the drain pan.

Objects of the present disclosure should not be limited to the aforementioned objects and other unmentioned objects will be clearly understood by those skilled in the art from the following description.

### Technical Solution

In accordance with an embodiment of the present disclosure, the above and other objects can be accomplished by the provision of air conditioner including a heat exchanger exchanging heat between air and refrigerant, a fan discharging air toward the heat exchanger, a first drain pan disposed in a direction crossed to a direction of air flowing from the fan to the heat exchanger, wherein the first drain pan has an inlet opening through which air discharged from the fan flows toward the heat exchanger, a second drain pan disposed in a direction parallel to a direction of air flowing from the fan to the heat exchanger and a water level sensor rotatably disposed with reference to a rotating center spaced apart from the first drain pan and the second drain pan, wherein the water level sensor detects a water level of water gathered in one of the first drain pan and the second drain pan.

The rotating center of the water level sensor may be spaced apart from the first drain pan by a first distance and be spaced apart from the second drain pan by a second distance, wherein the first distance and the second distance are the same.

The heat exchanger may comprise a housing forming an external appearance of the heat exchanger and a heat exchanging section through which refrigerant flows, wherein the heat exchanging section is disposed inclined with respect to a flow direction of air in the housing, wherein the first drain pan and the second drain pan are disposed outside the heat exchanging section in the housing, wherein one of the first drain pan and the second drain pan is disposed at a lower side of the heat exchanging section.

The water level sensor may comprise a detector detecting a water level of a drain pan disposed at a lower side of the heat exchanging section among the first and second drain pans, wherein the detector is disposed in a direction facing the drain pan disposed at the lower side of the heat exchanging section by gravity.

The air conditioner may further comprise a bracket mounted to at least one of the first drain pan and the second drain pan and a rotating member rotatably coupled to the bracket, wherein the water level sensor is coupled to the rotating member.

The rotating member may comprise a boss having a hollow disposed therein, a rotating shaft inserted to the bracket and the hollow and a coupling section connected to the water level sensor.

The rotating member may comprise a protrusion protruding from an outer circumference of the boss and a pin protruded from the protrusion to the bracket, wherein the bracket comprises a beam to which the rotating member is coupled in a state that the rotating shaft penetrates the beam and first and second rotation restricting projections protruded from the beam, wherein the rotating member is prevented from rotating in a direction from the first drain pan to the second drain pan in a state that the water level sensor faces the first drain pan on account that movement of the pin is restricted by the first rotation restricting projection, and wherein the rotating member is prevented from rotating in a direction from the second drain pan to the first drain pan in a state that the water level sensor faces the first drain pan on account that movement of the pin is restricted by the second rotation restricting projection.

The air conditioner may further comprise first and second stoppers protruded from the bracket in a direction parallel to the rotating shaft, wherein the rotating member further comprises connector connected to the coupling section, wherein the connector is spaced apart from the bracket by a less distance than a length of each of the first and second stoppers, wherein the connector is extended from the boss in a direction perpendicular to the rotating shaft, wherein the first stopper is placed in an opposite direction of the second drain pan with reference to the connector in a state that the connector faces the first drain pan, wherein the second stopper is placed in an opposite direction of the first drain pan with reference to the connector in a state that the connector faces the second drain pan.

The air conditioner may further comprise a bracket mounted to at least one of the first drain pan and the second drain pan, wherein the bracket comprises a beam rotatably supporting the water level sensor.

The bracket may comprise a frame disposed parallel to one of the first drain pan and the second drain pan and mounted to the one of the drain pans, wherein the frame is protruded from the coupling section in a direction parallel to the other drain pan.

The first drain pan may comprise a first base plate having an inlet opening, an inner rim being bent from a circumference of the inlet opening of the first base plate to the heat exchanger and an outer rim being bent from an outer circumference of the first base plate to the heat exchanger.

The air conditioner may further comprise a controller configured to regulate flow of refrigerant, wherein the controller stops the flow of refrigerant in a case that a water level detected by the water level sensor is greater than predetermined reference water level.

An air conditioner may comprise an intake duct through which air sucked from indoor flows, an indoor unit disposed outside of the indoor for allowing air sucked from the intake duct to exchange heat with refrigerant and be discharged, an exhaust duct guiding heat-exchanged in the indoor unit to the indoor and a controller controlling an operation of the indoor unit, wherein the indoor unit comprises a fan discharging air sucked from the intake duct to the exhaust duct a heat exchanger exchanging heat between air flowed by the fan and the refrigerant, a drain pan gathering condensate water generated in the heat exchanger and a water level sensor detecting a water level in the drain pan, wherein the controller stops an operation of the indoor unit in a case that a water level detected by the water level sensor is greater than a predetermined reference water level.

The drain pan may comprise a first drain pan disposed in a direction perpendicular to a direction of air flowing from the fan to the heat exchanger and a second drain pan disposed in a direction parallel to a direction of air flowing from the fan to the heat exchanger, wherein the water level sensor is rotatably disposed with reference to a rotating center spaced apart from the first drain pan and the second drain pan, wherein the water level sensor detects a water level of water gathered in one of the first drain pan and the second drain pan.

### Advantageous Effects

The air conditioner including the same according to the present disclosure provide at least the following effects.

First, the air conditioner has an advantage of including the water level sensor and detecting a water level of water gathered in the drain pan after being condensed in the heat exchanger.

Second, the indoor unit including a fan and the heat exchanger can be installed in the first direction or the second direction which is perpendicular to the first direction, wherein the drain pan includes a first drain pan disposed adjacently to a flow direction of air from the fan to the heat exchanger and a second drain pan disposed adjacently to a flow direction of air from the fan to the heat exchanger. Further, the water level sensor is rotatably disposed based on a center of rotation spaced apart from the first drain pan and the second drain pan. Therefore, it is further possible to detect a water level of water gathered in the drain pan through one water level sensor regardless of whether the indoor unit is installed in the first direction or in the second direction.

Third, a controller for controlling a flow of refrigerant in the air conditioner is capable of preventing condensate water generated in the heat exchanger from overflow from the drain pan by stopping the flow of refrigerant in a case that a water level detected by the water level sensor is greater than a predetermined reference water level.

It should be understood that advantageous effects according to the present invention are not limited to the effects set forth above and other advantageous effects of the present disclosure will be apparent from the detailed description of the present disclosure.

### DESCRIPTION OF DRAWINGS

FIG. 1 is a perspective view showing an air conditioner according to an embodiment of the present disclosure.

FIG. 2 is a block diagram showing a flow of refrigerant and a control of the air conditioner according to an exemplary embodiment of the present disclosure.

FIG. 3 is a perspective view showing a gas furnace of FIG. 1.

FIG. 4 is a perspective view showing a heat exchanger of indoor unit installed in the first direction.

FIG. 5 is a front view showing the heat exchanger of FIG. 4.

FIG. 6 is an enlarged view showing an area A of FIG. 5

FIG. 7 is a front view showing an indoor unit installed in the second direction.

FIG. 8 is an enlarged view showing an area B of FIG. 7.

FIG. 9 is a front view showing a water level sensor of an air conditioner according to an exemplary embodiment of the present disclosure.

FIG. 10 is a perspective view showing a water level sensor and a rotating member of FIG. 6.

FIG. 11 is an exploded perspective view showing the rotating member of FIG. 10.

FIG. 12 is an enlarged view showing the water level sensor of the indoor unit installed in the first direction and the rotating member.

FIG. 13 is an enlarged view showing the water level sensor of the indoor unit installed in the second direction and the rotating member.

### MODE FOR INVENTION

Advantages and features of the present disclosure and methods of achieving the advantages and features will be apparent with reference to embodiments described below in detail in conjunction with the accompanying drawings. However, the present disclosure is not limited to embodiments disclosed below, but may be implemented in various forms, only the present embodiments are provided so that a disclosure of the present disclosure is complete and a disclosure of a scope of the invention is fully understood by those skilled in the art to which the present disclosure belongs, and the present disclosure is only defined by the scope of the claims. The same reference numerals indicate the same components through the specification.

Hereinafter, an air conditioner according to an exemplary embodiment of the present disclosure will be described with the accompanying drawings.

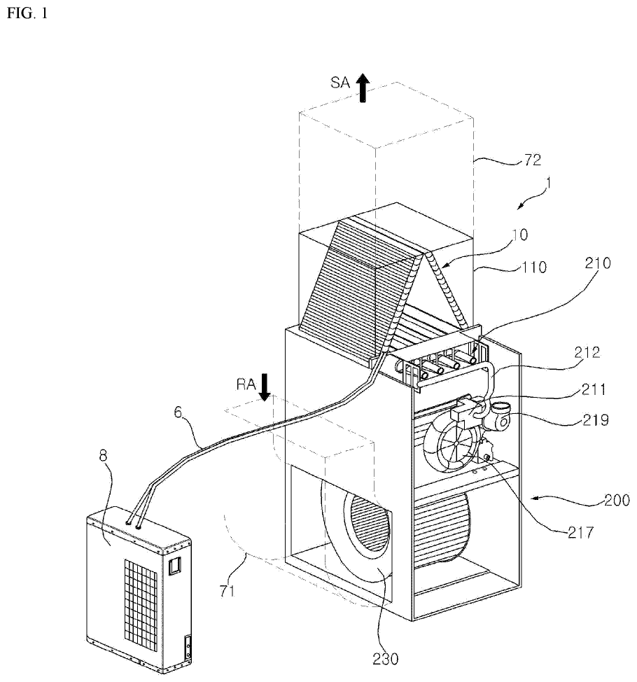

FIG. 1 is a perspective view showing an air conditioner according to an exemplary embodiment of the present disclosure.

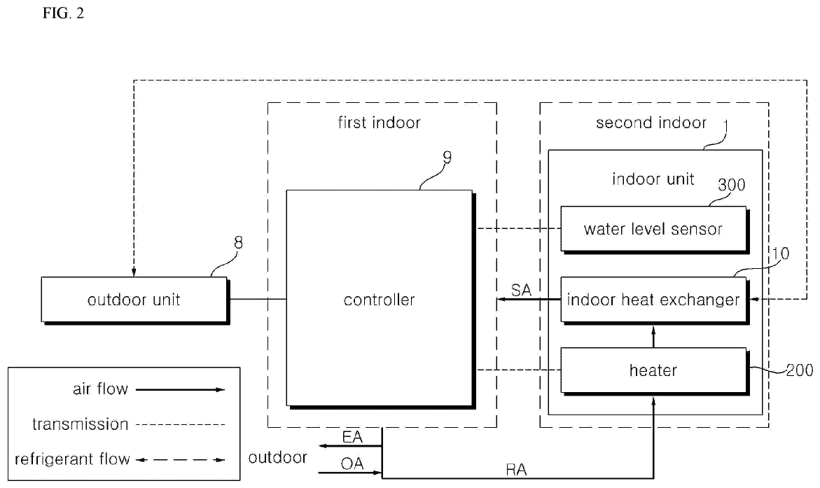

The air conditioner according to an exemplary embodiment of the present disclosure may connect an indoor (first indoor shown in FIG. 2) which a user stays and an indoor unit 1 disposed at the outside (second indoor shown in FIG. 2) the indoor through ducts 71, 72 so as to supply air conditioned air to the indoor. The ducts 71, 72 may include an intake duct guiding room air RA discharged from the first indoor to the indoor unit 1 and an exhaust duct 72 guiding supplying air SA releasing or absorbing heat while passing through the indoor unit 1

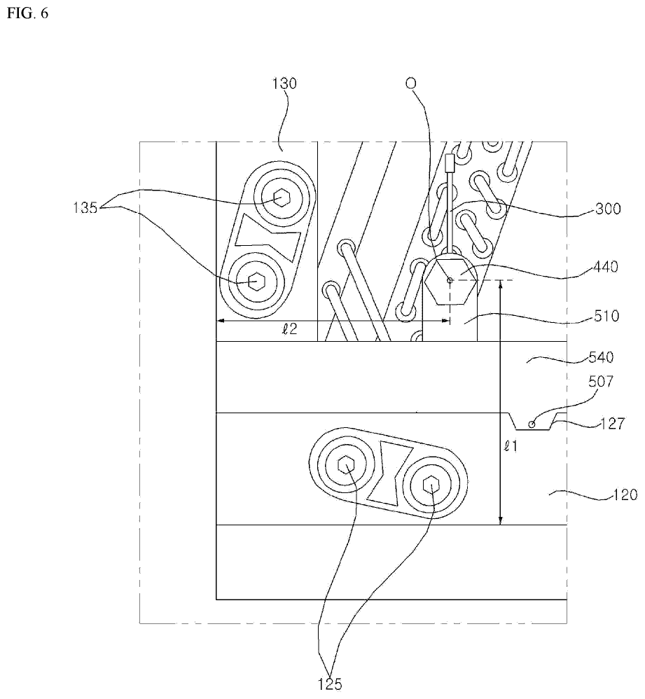

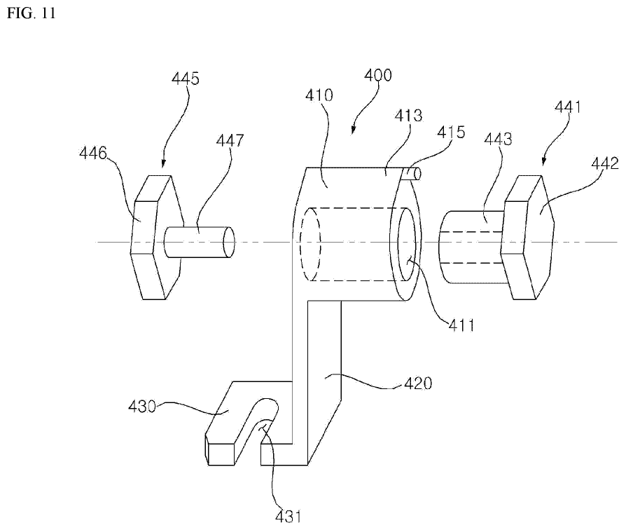

The air conditioner includes the indoor unit 1 allowing air to exchange heat with refrigerant so as to supply the air to the indoor. The indoor unit 1 includes a heat exchanger 10 exchanging heat between air and refrigerant, a fan 230 discharging air to the heat exchanger 10, drain pans 120, 130 gathering condensate water descended from the heat exchanger 10 and a water level sensor 300 detecting water level of water gathered in the drain pans 120, 130. Further, the indoor unit 1 may further include a bracket 500 (referred to FIG. 6) for mounting to the water level sensor 300 and a rotating member 400 (referred to FIG. 11) for mounting to the bracket 500 and the water level sensor 300.

The air conditioner may further include an outdoor unit 8 realizing a refrigeration cycle with the heat exchanger 10 of the indoor unit 1. The outdoor unit 8 may include a compressor (not shown) compressing refrigerant, an outdoor heat exchanger (not shown) exchanging heat between refrigerant and air and an expansion valve (not shown) expanding refrigerant. Further, the outdoor unit 8 may further include a four-way valve (not shown).

Hereinafter, the heat exchanger 10 even if there is no any expression of ‘indoor’ or ‘outdoor’, etc., will be meant to be an indoor heat exchanger 10. At this time, the heat exchanger 10 of the indoor 1 may be called an indoor heat exchanger 10 for distinguish between the outdoor heat exchanger and a heating heat exchanger 215 which is described later.

The outdoor unit 8 and the indoor heat exchanger 10 may be connected through a refrigerant passage 6. The refrigeration cycle can be realized by refrigerant flowing through the compressor of the outdoor unit 8, the outdoor heat exchanger, the expansion valve and the indoor heat exchanger 10. The refrigerant passage 6 may include a liquid passage 61 allowing liquid-phase refrigerant or two-phase refrigerant including liquid-phase and gas-phase refrigerant to flow therein and a gas passage 63 allowing gas-phase refrigerant to flow.

The controller 9 which is described later controls the four-way valve so as to guide refrigerant compressed in the compressor to the outdoor heat exchanger during cooling operation, and guide refrigerant discharged from the expansion valve to the indoor heat exchanger 10. The outdoor heat exchanger may function as a condenser supplying heat to air from gas-phase refrigerant, and the indoor heat exchanger 10 may function as an evaporator allowing two-phase refrigerant including liquid and gas to absorb heat from air. Refrigerant discharged from the expansion valve during cooling operation may be guided to the indoor heat exchanger 10 through the liquid passage 61, and refrigerant discharged from the indoor heat exchanger 10 may be guided to the compressor of the outdoor unit 8 through the gas passage 63.

The controller 9 controls the four-way valve so as to guide refrigerant compressed in the compressor to the indoor heat exchanger 10 during heating operation, and guide refrigerant discharged from the expansion valve to the outdoor heat exchanger. During heating operation, the indoor heat exchanger functions as a condenser causing gas-phase refrigerant to supply heat through air, and the outdoor heat exchanger functions as an evaporator causing two-phase refrigerant including liquid and gas to absorb heat from air. During heating operation, refrigerant discharged from the compressor may be guided to the indoor heat exchanger 10 through the gas passage 63, and refrigerant discharged from the indoor heat exchanger 10 may be guided to the expansion valve of the outdoor unit through the liquid passage 61.

The indoor heat exchanger 10 may include a housing 110 formed as an external appearance of the indoor heat exchanger 10 and heat exchanging sections 11, 12 through which refrigerant flows. The heat exchanging sections 11, 12 may be disposed in the housing 110, and disposed inclined along a flow direction of air. The heat exchanging sections 11, 12 may include a first heat exchanging section 11 and a second heat exchanging section 12 as described later. the farther from an inlet opening of the heat exchanger 10 disposed at a side of the fan 230, the closer the first heat exchanging section 11 and the second heat exchanging section 12 may be get. The structure having the heat exchanging sections 11, 12 as the above is so-called A-coil.

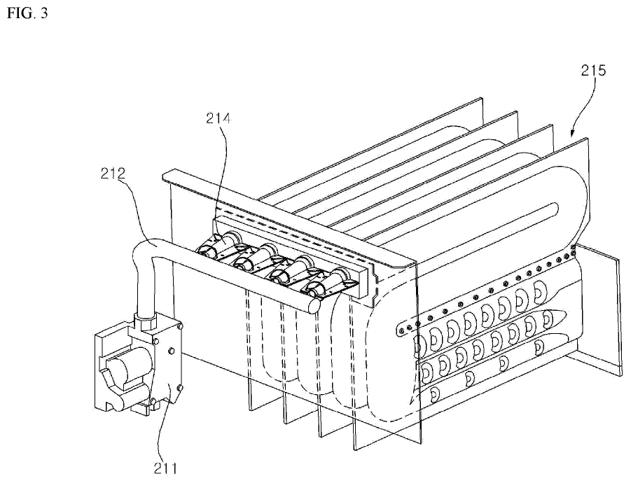

Meanwhile, the fan 230 may form a heater 200 using a gas furnace 210 disposed between the indoor heat exchanger 10 and the fan 230. Referring to FIG. 3, the gas furnace 210 will be described in detail below.

FIG. 2 is a block diagram showing a flow of refrigerant and a control of the air conditioner according to an exemplary embodiment of the present disclosure.

The air conditioner according to an exemplary embodiment of the present disclosure may include a display section (not shown) displaying an operating status of the air conditioner and an input section (not shown) for getting a command from a user, and the display section and the input section may be installed at the first indoor which a user stays. The controller 9 may display operation status of the air conditioner through the display section, and get a command about an operation through the input section from a user

The controller 9 may be disposed at the first indoor with the display section and the input section. Alternatively, the display section and the input section may be disposed at the first indoor while the controller 9 may be disposed at a basement room having the indoor unit 1 or attic which is the second indoor, otherwise may be disposed at outdoor in a state of being inside the outdoor unit 8.

The indoor unit 1 may be disposed at an outside of the first indoor which a user mainly stays. The first indoor may be an outside of a building, a basement room inside the building, or attic which is the second indoor. Preferably, the indoor unit 1 may be disposed in a basement room inside of the building or attic which is the second indoor.

The indoor unit 1 may include an indoor heat exchanger 10 and the fan 230. Further, the indoor unit 1 may further the gas furnace 210. Therefore, the indoor unit 1 may have the longer length along a direction which the fan 230 and the indoor heat exchanger 10 are arranged compared with a length along the other direction.

In a case that the indoor unit 1 is installed at a basement room, the indoor unit 1 can be installed along a first direction regardless of height. (referred to FIG. 1) That is, the first direction means that the indoor heat exchanger 10 is installed at an upper side of the heater 200 including the fan 230 and the gas furnace 210. At this case, a height from the heater 200 to the indoor heat exchanger 10 may be greater than a width between front and rear or left side and right side.

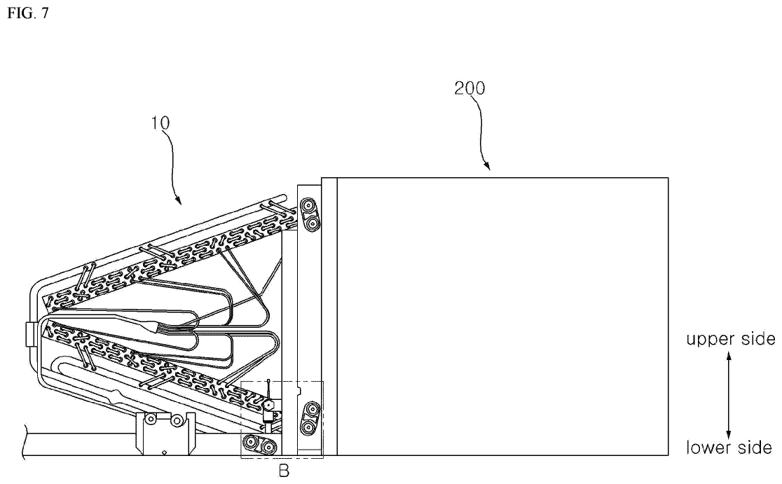

Unlike a basement room, an attic has its limitations due to low height, so the indoor unit can be installed along a second direction. (referred to FIG. 7) The second direction means that the indoor heat exchanger 10 is installed at the same height as the heater 200 including the fan 230 and the gas furnace 210 rather than an upper side of the heater 200.

The controller 9 may control an operation of the heater 200 and the outdoor unit 8. The controller 9 may operate the compressor during heating operation, and control the four-way valve so that refrigerant discharged from the compressor is guided to the indoor heat exchanger 10. Further, the controller 9 may operate the fan 230 so as to intake air from the first indoor, and blow air to the indoor heat exchanger 230 and the exhaust duct 72. The air may be supplied to the first indoor through the exhaust duct 72.

Further, the controller 9 may operate the gas furnace 210 during heating operation so as to supply heat to air sucked from the first indoor. The controller 9 may operate one or the both among an operation of the compressor for refrigerant flow during heating operation and an operation of the gas furnace 210. In doing so, the air conditioner may supply air having higher temperature than air in the first indoor to the first indoor.

The controller 9 may stop the gas furnace 210 during cooling operation, and operate the compressor, and then control the four-way valve so that refrigerant discharged from the compressor is guided to the outdoor heat exchanger and refrigerant discharged from the expansion valve is guided to the outdoor heat exchanger 10. Further, the controller 9 may operate the fan 230 so as to suck air in the first indoor and the air is flowed to the indoor heat exchanger 10 and the exhaust duct 72. The air may be supplied to the first indoor through the exhaust duct 72. In doing so, the air conditioner may supply air having low temperature than air in the first indoor to the first indoor.

Meanwhile, the air conditioner may further include ventilation system. The ventilation system may be connected with an intake duct 71 so as to discharge a little amount of air in the first indoor, and suck air from outside. By using the ventilation system, contaminated air, e.g., air having high density of dioxide carbon, in indoor can be discharged to outside, and fresh air, e.g., air having high density of oxygen, from outside can be supplied to the first indoor.

In the mean time, refrigerant having the lower temperature than air sucked from the first indoor can flow during cooling operation, moisture included in the air can be condensed on a surface of the heat exchanging sections 11, 12. Condensate water may be descend by gravity, or flowed along on a surface of the heat exchanging sections 11, 12 downwardly. The condensate water may be gathered in the drain pan 120, 130 disposed at a lower side of the heat exchanging sections 11, 12.

In a case that cooling operation continues, the water gathered in the drain pan may exceed the amount acceptable to the drain pan 120, 130 and may overflow from the drain pan 120, 130. As can be seen from the foregoing, the indoor unit 1 may be installed at a basement room, an attic which is second indoor, etc., and the basement room or the attic is prone to be contaminated due to much dirt and high humidity. Therefore, even if drain passage is connected to the drain pan 120, 130, the drain passage may be clogged so that water gathered in the drain pan 120, 130 may overflow from the drain pan 120, 130. Additionally, because the basement room or attic is not a space which many people get in and out frequently, it is difficult to recognize condensate water overflowing from the drain pan 120, 130 immediately.

The air conditioner includes a water level sensor 300 for detecting a water level in the drain pans 120, 130. The controller 9 may control an operation of the indoor unit based on the water level detected by the water level sensor 300. The controller 9 may further include a memory (not shown) storing information about an operation of the air conditioner. A predetermined reference water level may be stored in the memory in advance. The predetermined reference water level may be set to a water level which is lower than the maximum acceptable level of the drain pans 120, 130.

The controller 9 may control flow of refrigerant based on a water level detected by the water level sensor 300. The controller 9 may control the flow of refrigerant by comparing a reference water level set to the lower level than the maximum acceptable level of the drain pans 120, 130 with a water level detected by the water level sensor 300. The controller 9 may stop a flow of refrigerant when a water level detected by the water level sensor 300 is greater than the reference water level.

The flow of refrigerant is generated by an operation of the compressor. And the controller 9 may control flow of refrigerant by controlling an operation of the compressor based on a water level detected by the water level sensor 300. Because flow of refrigerant through the indoor heat exchanger 10 is controlled by the operation of the compressor, controlling the operation of the compressor will be described as the same as controlling the operation of the indoor heat exchanger 10.

Furthermore, the controller 9 may indicate on the display section that a water level of water gathered in the drain pans 120, 130 is greater than the reference water level. In addition, when a water level detected by the water level sensor 300 is greater than the reference water level, the controller 9 stop the operation of the fan 230. In this case, user can easily recognize a status having a problem without staring the display section.

FIG. 3 is a perspective view showing the gas furnace of FIG. 1.

The gas furnace is a device heating indoor room by supplying flame generated by combustion of fuel gas and heat-exchanged air to indoor.

As shown in FIG. 3, the gas furnace 210 includes a gas valve 211 supplying fuel gas to a manifold 212, a burner 214 through which gas-mixture containing fuel gas discharged from the manifold 212 and air flow and a heating heat exchanger 215.

Fuel gas supplied through the gas valve 211 may be liquefied natural gas (LNG) made from being liquefied from natural gas or liquefied petroleum gas (LPG) generated by pressurizing gas obtained from byproduct during oil refining process.

Supplying fuel gas to the manifold 212 may be performed according to opening or closing of the gas valve 211. And, adjusting an opening of the gas valve 211 may be performed to adjusting an amount of fuel gas supplying to the manifold 212. The controller 9 may control the gas valve 211 to be opened or closed, or adjust the opening of the gas valve 211.

The manifold 212 may guide fuel gas to the burner 214. Fuel gas guided to the burner 214 may be flowed in a state of forming gas-mixture with air.

The gas-mixture flowing through the burner 214 may be combusted by a spark of an igniter. In this case, combusting the gas-mixture may make flame and high-temperature combustion gas.

A passage for allowing a combustion gas to flow may be formed at the heating heat exchanger 215 of the gas furnace 210.

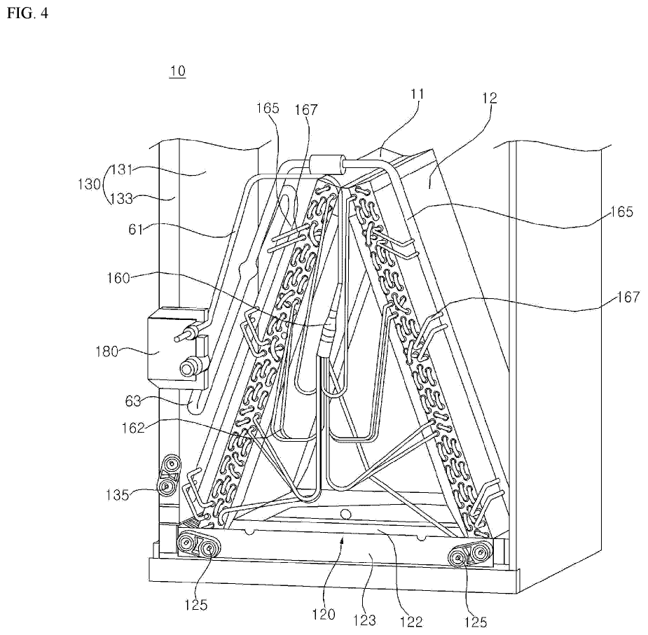

FIG. 4 is a perspective view showing the heat exchanger 10 of the indoor unit 1 installed along the first direction.

The indoor unit 1 of the air conditioner according to an exemplary embodiment of the present disclosure includes a heat exchanger 10 exchanging heat between air and refrigerant and drain pans 120, 130 gathering condensate water generated on a surface of the heat exchanger 10 on which moisture contained in air is condensed. The drain pans 120, 130 include a first drain pan 120 disposed crossed to a flow direction of air and a second drain pan 130 disposed parallel to a flow direction of air.

The indoor unit 1 may be installed along a direction which the first drain pan 120 is disposed at a lower side of the heat exchanger 10, and that is so-called a first direction.

The indoor unit 1 may further include a fan 230 blowing air toward the heat exchanger 10. An inlet opening of the heat exchanger 10 and an outlet opening of the fan 230 may be arranged to face to each other. If the indoor unit 1 is installed in the first direction, the outlet opening of the fan 230 may face upward, and the inlet opening of the heat exchanger 10 may face downward. If the indoor unit 1 is installed in the first direction, the heat exchanger 10 may be disposed at an upper side of the fan 230.

The indoor unit 1 may include the gas furnace 210. The fan 230 may form the heater 200 using the gas furnace 210. The fan 230, the gas furnace 210 and the heat exchanger 10 may be sequentially arranged in the indoor unit 1 along a flow direction of air. If the indoor unit 1 is installed in the first direction, the gas furnace 210 may be disposed at an upper side of the fan 230, and the indoor heat exchanger 10 may be disposed at an upper side of the gas furnace 210.

If the indoor unit 1 is installed in the first direction, a height defined as a length from a bottom to the indoor heat exchanger 10 may be greater than a width between front and rear or left side and right side. In case of installing the indoor unit 1 in a basement room, because basement room is not limited in height, there is no problem that the indoor unit 1 is installed in the first direction. (referred to FIG. 1)

The heat exchanger 10 may include the housing 110 (referred to FIG. 1) forming an external appearance of the heat exchanger 10 and heat exchanging sections 11, 12 through which refrigerant flows. The heat exchanger 10 may further include a refrigerant distributor 160 connected to the liquid passage 61 and a header pipe 165 connected to the gas passage 63.

An outlet opening and an inlet opening of the heat exchanger 10 may be formed at the housing 110. The inlet opening of the heat exchanger 10 may be connected to the outlet opening of the heater 200, and the outlet opening of the heat exchanger 10 may be connected to the exhaust duct 72.

A space may be formed inside the housing 110. Heat exchanging sections 11, 12 and drain pans 120, 130 may be disposed inside the housing 110. The refrigerant distributor 160 and the header pipe 165 may be disposed inside the housing 110. A portion of the gas passage 63 and the liquid passage 61 facing the indoor heat exchanger 10 may be disposed inside the housing 110.

The heat exchanging sections 11, 12 may be disposed inclined to a flow direction of air in the housing 110. The heat exchanging sections 11, 12 may include the first heat exchanging section 11 and the second heat exchanging section 12. The first heat exchanging section 11 and the second heat exchanging section 12 may be symmetrically arranged in relation to a plane parallel to flow direction of air.

The closer the first heat exchanging section 11 may be disposed to the outlet opening from the inlet opening of the heat exchanger 10, the more inclined the first heat exchanging section 11 get along a direction far away from the housing. The closer the second heat exchanging section may be disposed to the outlet opening from the inlet opening of the heat exchanger 10, the more inclined the second heat exchanging section get along a direction far away from the housing 110. In other words, the first heat exchanging section 11 and the second heat exchanging section 12 have a first each end spaced apart from each other at a side of the inlet opening and a second each end closely disposed to each other at a side of the outlet opening. The first heat exchanging section 11 and the second heat exchanging section 12 may be contacted at the first each end, the first heat exchanger and the second heat exchanger may be spaced apart from each other at the second each end

The first heat exchanging section 11 and the second heat exchanging section 12 may include a plurality of tubes through which refrigerant flows. Refrigerant flowing through the plurality of tubes may exchange heat with air through the fan 230.

The refrigerant distributor 160 may have a first end connected to the liquid passage 61. The refrigerant distributor 160 may distribute refrigerant flowed from the liquid passage 61 to the plurality of tubs. The plurality of tubes may be a plurality of first connecting passages 162.

The indoor heat exchanger 10 may include a plurality of first connecting passages 162 connected to a second end of the refrigerant distributor 160. The plurality of first connecting passages 162 may connect the refrigerant distributor 160 and the heat exchanging sections 11, 12. The plurality of first passages 162 may connect the second end of the refrigerant distributor 160 and the plurality of tubes of the heat exchanging sections 11, 12. The plurality of first connecting passages 162 may guide refrigerant distributed by the refrigerant distributor 160 to the plurality of tubes.

The header pipe 165 may be connected to the plurality of tubes. The header pipe 165 may be connected to the gas passage 63. The header pipe 165 may guide refrigerant discharged from the plurality of tubes to the gas passage 63.

The indoor heat exchanger 10 may further include a plurality of second connecting passages 167 connecting a plurality of tubes of the heat exchanging sections 11, 12 and the header pipe 165. Refrigerant discharged from the plurality of tubes flows into the header pipe 165 through the plurality of second connecting passages 167, and then flows into the gas passage 63 through the header pipe 165. Refrigerant flowed into the gas passage 63 flows into the outdoor unit 8.

Meanwhile, the refrigerant flow of the refrigerant distributor 160 and the header pipe 165 is corresponded to a case of cooling operation, and the flow direction will be reversed in case of heating operation. Thus, in case of heating operation, refrigerant discharged from the compressor of the outdoor unit 8 flows into the header pipe 165 through the gas passage 63, and then is distributed to the plurality of second connecting passages 167 so as to exchange heat with air while flowing through the plurality of tubes. And, the refrigerant flows into the outdoor unit 8 through the liquid passage 61 after flowing into the refrigerant distributor 160 through the first connecting passage 162.

The drain pan 120, 130 may be disposed inside the housing 110. The drain pans 120, 130 may be disposed outside of the heat exchanging sections 11, 12. The first drain pan 120 may be disposed crossed to a flow direction of air, and the second drain pan 130 may be disposed parallel to a flow direction of air. The first drain pan 120 may be disposed perpendicular to a flow direction of air, the second drain pan 130 may be disposed perpendicular to the first drain pan 120.

The first drain pan 120 may be disposed at a lower side of the heat exchanging sections 11, 12 with respect to the indoor heat exchanger disposed in the first direction, and the second drain pan 130 may be disposed at one direction of front, rear, left and right of the heat exchanger. The first drain pan 120 and the second drain pan 130 may have each one end disposed in a direction facing an edge formed at a lower side of the housing 110. The first drain pan 120 may be disposed parallel with respect to the indoor heat exchanger 10 disposed in the first direction.

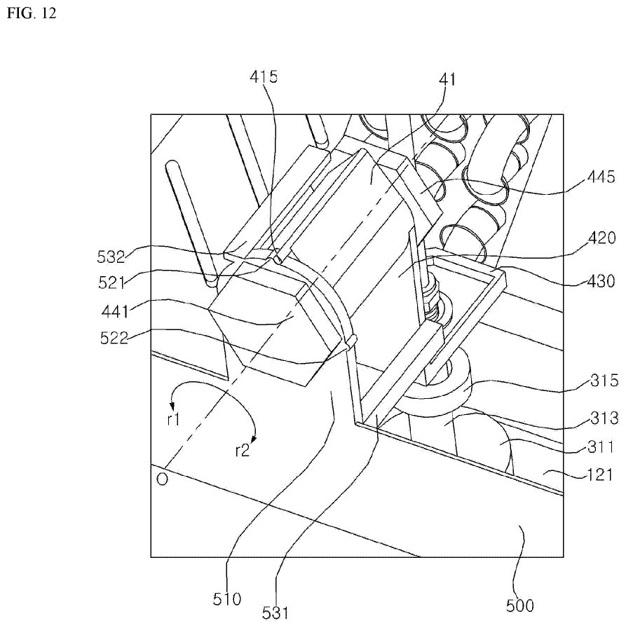

The first drain pan 120 may include a first base plate 121 (referred to FIG. 12) disposed at a lower side of the heat exchanging sections 11, 12 with respect to the indoor heat exchanger 10 disposed in the first direction and an outer rim 123 extended upwardly toward indoor heat exchanger 10 from an outer circumference of the first base plate 121.

The first base plate 121 may be formed as a plate formed as a shape of ring. The first base plate 121 may be a shape of rectangular ring. The first base plate 121 may include a communicating opening connected to the inlet opening of the indoor heat exchanger 10 therein. Further, a lower side of the housing 110 is opened with respect to the indoor heat exchanger 10 disposed in the first direction. The first base plate 121 forms a bottom surface of the indoor heat exchanger 10. The communicating opening disposed inside the first base plate 121 may be an inlet opening of the indoor heat exchanger 10.

The first drain pan 120 may further include an inner rim 122 extended upwardly toward the indoor heat exchanger 10 from an inner circumference of the first base plate 121 with respect to the indoor heat exchanger 10 disposed in the first direction. Each end of the first and second heat exchanging sections 11, 12 in a direction toward the inlet opening may be disposed between the inner rim 122 of the first drain pan 120 and the outer rim 123.

In a case that the indoor heat exchanger 10 is disposed in the first direction, condensate water generated in the first and second heat exchanging sections 11, 12 flows to the first drain pan 120 through the first and second heat exchanging sections 11, 12, or descends toward the first drain pan 120. The condensate water may be gathered in a space formed by the outer rim 123 of the first drain pan 120, the first base plate 121 and the inner rim 122.

The first drain pan 120 may include an exhaust port 125 disposed at the outer rim 123. The exhaust port 125 may be provided in plurality, and further disposed at the both ends of the outer rim 123. Condensate water gathered in the first drain pan 120 may discharged to outside through the exhaust port 125. The indoor unit 1 may further include an exhaust hose (not shown) connected to the exhaust port 125. The exhaust hose is able to guide condensate water discharged through the exhaust port 125 to outside.

The second drain pan 130 may be disposed horizontal with respect to the indoor heat exchanger 10 disposed in the second direction as described below. (referred to FIG. 7) The second drain pan 130 may include a second base plate 130 disposed at a lower side of the heat exchanging sections 11, 12 with respect to the indoor heat exchanger 10 disposed in the second direction as described below (referred to FIG. 7), and an outer rim 133 extended upwardly from an outer circumference of the second base plate 131. The second base plate 131 may be formed as a shape of plate. Additionally, the second base plate 131 may be formed as plate having a shape of rectangular.

In a case that the indoor heat exchanger 10 is disposed in the second direction, condensate water generated in the first and second heat exchanging sections 11, 12 flows to the second drain pan 130 through the first and second heat exchanging sections 11, 12, or descends toward the second drain pan 130. The condensate water may be gathered in a space formed by an opened upper side of the outer rim 133 of the second drain pan 130 and the second base plate 131.

The second drain pan 130 may include an exhaust port 135 disposed at the outer rim 133. The exhaust port 135 may be disposed at an end of the outer rim 133 in a direction facing the first drain pan 120. The exhaust port 135 may be provided in plurality, and disposed at the both ends of the outer rim 133. Condensate water gathered in the second drain pan 130 may be discharged to outside through the exhaust port 135. The indoor unit 1 may further include an exhaust hose (not shown) connected to the exhaust port 135. The exhaust hose may guide condensate water discharged from the exhaust port 135 to outside.

The indoor heat exchanger 10 may further include a mount 180 supporting the liquid passage 61 and the gas passage 63. The mount 180 may be mounted to the outer rim 133 of the second drain pan 130.

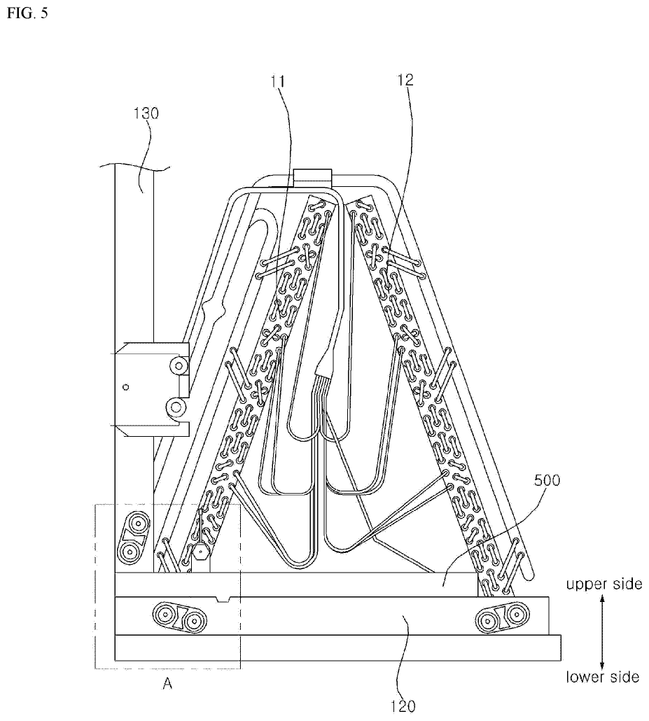

FIG. 5 is a front view showing the heat exchanger of FIG. 4 and FIG. 6 is an enlarged view showing an area A of FIG. 5

Referring to FIG. 5 and FIG. 6, the air conditioner according to an exemplary embodiment of the present disclosure includes the water level sensor 300 detecting a water level of water gathered in the drain pans 120, 130. The water level sensor 300 is rotatably disposed with respect to a rotating center O spaced apart from the first drain pan 120 and the second drain pan 130. The rotating center O may be spaced apart from the first drain pan 120 by a first distance 11, and be spaced apart from the second base plate 131 by a second distance 12. The first distance 11 may be the same as the second distance 12.

The air conditioner may further include a bracket 500 connected to the drain pan 120 in which the bracket 500 supports the water level sensor 300 so that the water level sensor 300 can rotate. The bracket 500 may include a frame 540 mounted to the drain pan 130 and a beam 510 supporting the water level sensor 300 in a state of enabling to rotate.

The frame 540 may be mounted to at least one drain pan of the first drain pan 120 and the second drain pan 130. The frame 540 may be disposed parallel to the first drain pan 120 or the second drain pan 130. For example, a case that the frame 540 is disposed parallel to the first drain pan 120 will be described in the followings.

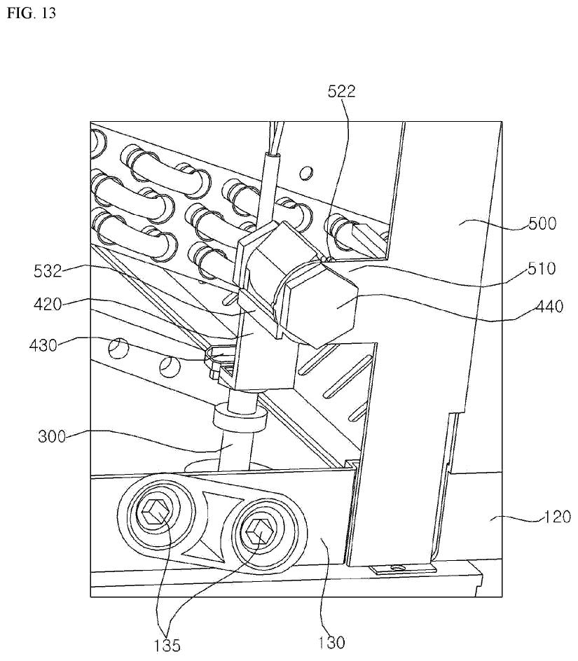

A mounting hole 507 may be formed at the frame 540. The outer rim 123 of the first drain pan 120 may include a mounting groove 127 formed at a position corresponding to the mounting hole 507. A coupling section (not shown) may be inserted to the mounting groove 127 and the mounting hole 507, so the frame 540 may be mounted to the first drain pan 120. Unlike the mounting groove shown in FIG. 6, The mounting groove 127 may be formed as hole. Furthermore, the frame 540 may be mounted to the housing 110 as shown FIG. 13.

The beam 510 may protrude from the frame 540. The beam 510 may protrude in a direction parallel to the second drain pan 130 from the frame 540. The beam 510 may protrude in a direction parallel to the second drain pan 130 at a position spaced apart as the second distance 12 from the second drain pan 130. The beam 510 may include a shaft groove (not shown) through which a rotating shaft 440 penetrates as described later. The shaft groove may disposed at a position spaced apart as the first distance 11 from the first drain pan 120, and further as the second distance 12 from the second drain pan 130. A center of the shaft groove may be positioned at a rotating center O of the water level sensor 300.

The rotating shaft 440 may be inserted to a hollow 411 formed between the shaft groove and a boss 410 of the rotating member 400. The beam 510 may support rotation of the rotating member 400. The rotating member 400 may mounted to the water level sensor 300 so that the water level sensor 300 is rotate with respect to the rotating center O.

In case of installing the indoor unit 1 in the first direction, the rotating member 400 may be arranged in a direction facing the first drain pan 120 by gravity. Center of mass in the water level sensor 300 and the rotating member 400 may be positioned biased toward of a detector 310 of the water level sensor 300. Thus, when the indoor unit 1 is installed in the first direction, the detector 310 would face the first drain pan 120.

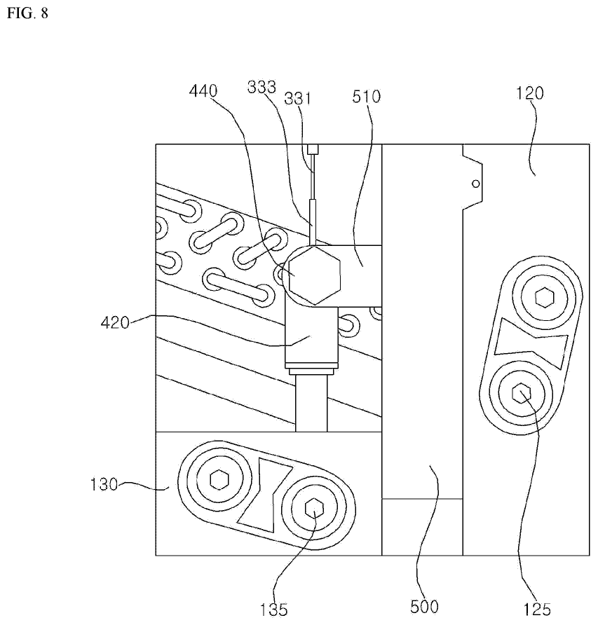

FIG. 7 is a front view showing the indoor unit 1 installed in the second direction, and FIG. 8 is an enlarged view showing area B of FIG. 7.

Referring to FIG. 7 and FIG. 8, the indoor unit 1 of the air conditioner according to an exemplary embodiment of the present disclosure may be installed in a direction which the second drain pan 130 disposed parallel to a flow direction of air is disposed at a lower side of the heat exchanger 10, and the direction is called second direction. When the indoor unit 1 is installed in the second direction, the heat exchanger 10 may be disposed at a height corresponding to the fan 230 rather than an upper side and a lower side of the fan 230. The indoor unit 1 may further include the gas furnace 210. The gas furnace 210 may be disposed at a lateral surface of the fan 230. The indoor heat exchanger 10 may be disposed at a lateral surface of the gas furnace 210.

When the indoor unit 1 is installed in the second direction, a width defined as a length along a direction toward the indoor heat exchanger 10 at the heater 200 may be greater than a height from a bottom end of the indoor unit 1 to an upper end thereof When the indoor unit 1 is installed at an attic, the indoor unit 1 may be installed in the second direction.

When the indoor unit 1 is installed in the second direction, the water level sensor 300 and the rotating member 400 may be arranged in a direction facing the second drain pan 130. Center of mass in the water level sensor 300 and the rotating member 400 may be arranged biased toward a position of the detector 310 of the water level sensor 300. Thus, the detector 310 may face the second drain pan 130.

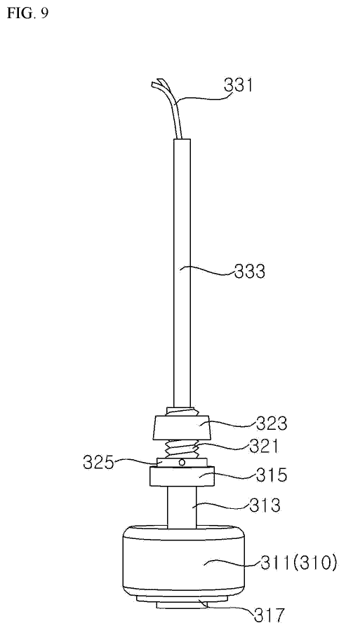

FIG. 9 is a front view showing the water level sensor 300 of the air conditioner according to an exemplary embodiment of the present disclosure. The water level sensor 300 detects a water level of water gathered in one drain pan of the first drain pan 120 and the second drain pan 130. The water level sensor 300 detects a water level of water gathered in the first drain pan 120 in a case that the indoor unit 1 (as known also the indoor heat exchanger 10) is installed in the first direction, and on the other hand the water level sensor 300 detects a water level of water gathered in the second drain pan 130 in a case that the indoor unit 1 (as known also the indoor heat exchanger 10) is installed in the second direction.

The water level sensor 300 is able to detect a water level according to a displacement of a float 311 in relative to a base of the water level sensor 300 wherein the float has a less density than water. Alternatively, it is possible to detect a water level with electrodes disposed at each different height. Hereinafter, detecting water level in case of using the float 311 will be described below.

The water level sensor 300 includes the detector 310. The detector 310 may be the float 311 able to move along a float guide 313 as described later. The water level sensor 300 is able to generate an electric signal according to a position of the float 311. The electric signal can be generated by converting a change according to a movement of the float 311 into an electric signal, or by a hall sensor provided with a magnet. The water level sensor 300 is able to transmit the electric signal to the controller 9.

The water level sensor 300 includes the float 311 having a less density than water, the float guide 313 guiding a movement of the float 311 upwardly or downwardly, a lower ring 317 protruding from a bottom end of the float guide 313 to outside and an upper ring 315 protruding from an upper end of the float guide 313 to outside. The lower ring 317 is able to restrict a downward movement of the float 311, and the upper ring 315 is able to restrict an upward movement of the float 311. Thus, the float 311 is able to move along the float guide 313 upwardly or downwardly between the lower ring 317 and the upper ring 315.

The water level sensor 300 may include a screw 321 having threads on an upper side of the upper ring 315. The water level sensor 300 may further include an elastic member 325 disposed at a lower side of the screw 321 and a nut 323 screwed to the screw 321.

The water level sensor 300 may further include a cable 331 transmitting an electric signal generated in the detector 310 to the controller 9. Further, the water level sensor 300 may further include a support pipe 333 encompassing the cable 331 at an upper side of the screw 321.

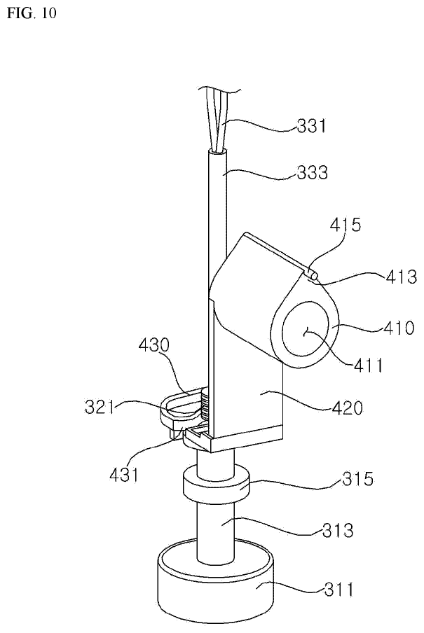

FIG. 10 is a perspective view showing the water level sensor 300 and the rotating member of FIG. 6.

Referring to FIG. 10, the air conditioner according to an exemplary embodiment of the present disclosure may further include the rotating member 400 rotatably coupled to the bracket 500. The rotating member 400 includes the boss 410 in which hollow is formed, a coupling section 430 connected to the water level sensor 300 and a connector 420 connecting the boss 410 and the coupling section 430.

The boss 410 may be formed as a shape of cylinder having a hollow therein, and may include a protrusion 413 protruding from an outer circumference of the boss 410. The rotating member 400 may further include a pin 415 mounted to the protrusion 413. The pin 415 may protrude parallel to the rotating center O of the water level sensor 300 from the protrusion 413. The pin 415 may protrude parallel to the rotating center O, and specially protrude toward the bracket 500.

The connector 420 may be extended downwardly from the boss 410. The connector 420 may be extended from the boss 410 at the opposite direction of the direction which the pin 415 protruded. The coupling section 430 may be disposed at a lower side of the connector 420. The coupling section 430 may be disposed at the opposite side of the boss 410 with reference to the connector 420. The connector may be disposed horizontally. The connector 430 may include a groove 431 in which the water level sensor 300 is inserted.

The screw 321 of the water level sensor 300 may be inserted to the groove 431 disposed at the coupling section 430. The elastic member 325 may be disposed at a lower side of the coupling section 430 and the nut 323 of the water level sensor 300 may be disposed at an upper side of the coupling section 430. The water level sensor 300 may be mounted to the coupling section 430 of the rotating member 400 by tightening the nut 323 in a state that the screw 321 is inserted to the groove 431 of the coupling section 430. The water level sensor 300 and the rotating member 400 are mounted together so as to be rotated integrally with reference to the rotating center O.

Referring to FIG. 11 and FIG. 12, the air conditioner according to an exemplary embodiment of the present disclosure may further include the rotating shaft 440 providing a rotating center O of the water level sensor 300 and the rotating member 400. The rotating shaft 440 may include a first shaft inserted to a shaft groove disposed at the beam 510 of the bracket 500 and the hollow 411 of the boss 410 and a second shaft 445 inserted to the hollow 411 of the boss 410 at the opposite side of the bracket 500 in which the second shaft 445 is mounted to the first shaft 441.

The first shaft 441 may include a head 442 and an outer shaft 443. The head 442 of the first shaft 441 and the boss 410 may be disposed at the opposite side each other with reference to the beam 510. The head 442 of the first shaft 441 may be larger than a shaft groove formed at the beam 510. The outer shaft 443 of the first shaft 441 may be a shape of cylinder having a hollow therein. The outer shaft 443 of the first shaft 441 may protrude the shaft groove and be inserted to the hollow 411 formed at the boss 410 so as to support a rotating of the rotating member 400.

The second shaft 445 may include a head 446 and an inner shaft 447. The head 446 of the second shaft 445 may be larger than the hollow 411 formed at the boss 410. The inner shaft 447 of the second shaft 445 may inserted to the hollow 411 of the boss 410 and a hollow formed at the outer shaft 443 of the first shaft 441 so as to be mounted to the first shaft 441. The inner shaft 447 may be screwed, or mounted thereto in any other manners. The first shaft 441 and the second shaft 445 are mounted together, so a rotating of the rotating member 400 is supported by the beam 510.

Referring to FIG. 12 and FIG. 13, the bracket 500 may include rotation restricting projections 521, 522 protruded from the beam 510. The rotation restricting projections 521, 522 may include a first rotation restricting projection 521 restricting a rotation of the rotating member 400 and the water level sensor 300 in a first rotating direction r1 and a second rotation restricting projection 522 restricting a rotation of the rotating member 400 and the water level sensor 300 in a second rotating direction r2.

The beam 510 may have a part formed as a shape of arc. An angle of the arc may be greater than an angle between the first base plate 121 and the second base plate 131. While the rotating member 400 rotates about the rotating center O, the pin 415 is able to move along an outer circumference of the arc of the beam 510. The first and second rotation restricting projections 521, 522 may protrude outwardly from the outer circumference of the arc. The pin 415 may be disposed between the first rotation restricting projection 521 and the second rotation restricting projection 522. The first rotation restricting projection 521 may be placed toward the first rotating direction r1 of the pin 415, and the second rotation restricting projection 522 may be placed toward the second rotating direction r2 of the pin 415.

When the indoor unit 1 is arranged in the first direction, the water level sensor 300 may face the first drain pan 120 by gravity. In a state that the water level sensor 300 faces the first drain pan 120, the pin 415 is prevented to move by the first rotation restricting projection 521, whereby the rotating member 400 is prevented to move along the first rotating direction r1. The first rotating direction r1 means that the water level sensor 300 in a state of facing the second drain pan 130 rotates along a direction facing the first drain pan 120.

When the indoor unit is arranged in the second direction, the water level sensor 300 may face the second drain pan 130 by gravity. In a state that the water level sensor 300 faces the second drain pan 130, the pin 415 is prevented to move by the second rotation restricting projection 522, whereby the rotating member 400 is prevented to move along the second rotating direction r2. The second rotating direction r2 means that the water level sensor 300 in a state of facing the first drain pan 120 rotates along a direction facing the second drain pan 130.

Meanwhile, the bracket 500 may further include stoppers 531, 532 protruding in a direction parallel to the rotating shaft 440. The stoppers 531, 532 may include a first stopper 531 restricting rotation of the rotating member 400 and the water level sensor 300 along the first rotating direction r1 and a second stopper 532 restricting rotation thereof along the second rotating direction r2.

The connector 420 is spaced apart from the beam 510 and the frame 540 in a direction parallel to the rotating center O. The stoppers 531, 532 protrude from the bracket 500 in a direction parallel to the rotating center O. And, each length of the stoppers 531, 532 may be greater than a distance between the connector 420 and the beam 510. Each length of the stoppers 531, 532 may be greater than a distance between the connector 420 and the frame 540

The connector 420 may be disposed between the first stopper 531 and the second stopper 532. The first stopper 531 may be disposed toward the first rotating direction r1 of the connector 420. The second stopper 532 may be disposed toward the second rotating direction r2 of the connector 420.

The first stopper 531 may be disposed at an opposite side of the second drain pan 130 with reference to the connector 420 in a state that the connector 420 faces the first drain pan 120. The second stopper 532 may be disposed at an opposite side of the first drain pan 120 with reference to the connector 420 in a state that the connector 420 faces the second drain pan 130.

In a state that the water level sensor 300 faces the first drain pan 120, the first stopper 531 restricts rotation of the connector 420, whereby rotation of the rotating member 400 along the first rotating direction r1 may be restricted. In a state that the water level sensor 300 faces the second drain pan 130, the second stopper 532 restricts rotation of the connector 420, whereby rotation of the rotating member 400 along the second rotating direction r2 may be restricted.

With reference to the indoor unit 1 arranged in the first direction, one of the first rotation restricting projection 521 and the first stopper 531 may be placed over the rotating center O and the other may be placed below the rotating center O.

With reference to the indoor unit 1 arranged in the second direction, one of the second rotation restricting projection 522 and the second stopper 532 may be placed over the rotating center O and the other may be placed below the rotating center O.

Although the embodiments of the present disclosure are described above with reference to the accompanying drawings, the present disclosure is not limited to the above embodiments, and may be manufactured in various forms, and in the art to which the present disclosure belongs, those skilled in the art will appreciate that the present disclosure may be embodied in other specific forms without changing the technical spirit or essential features of the present disclosure. Therefore, it should be understood that the embodiments described above are exemplary in all respects and not restrictive.

1-14. (canceled)

15. An air conditioner comprising:
a heat exchanger configured to exchange heat between air and refrigerant;
a fan configured to blow air in a first direction toward the heat exchanger;
a first drain pan that extends in a second direction crossing the first direction, the first drain pan defining an inlet opening configured to transmit the air blown by the fan toward the heat exchanger;
a second drain pan that extends in the first direction; and
a water level sensor configured to rotate about a rotating center that is spaced apart from the first drain pan and the second drain pan, the water level sensor being configured to detect a water level of water in one of the first drain pan or the second drain pan.

16. The air conditioner of claim 15, wherein a first distance between the rotating center of the water level sensor and the first drain pan is equal to a second distance between the rotating center of the water level sensor and the second drain pan.

17. The air conditioner of claim 15, wherein the heat exchanger comprises:
a housing that defines an external appearance of the heat exchanger; and
a heat exchanging section disposed in the housing and configured to carry the refrigerant and inclined with respect to the first direction,
wherein the first drain pan and the second drain pan are disposed outside the heat exchanging section in the housing, and
wherein one of the first drain pan or the second drain pan is disposed at a lower side of the heat exchanging section.

18. The air conditioner of claim 17, wherein the water level sensor comprises a detector that is configured to, based on rotation of the water level sensor, face the one of the first drain pan or the second drain pan and detect the water level of water in the one of the first drain pan or the second drain pan.

19. The air conditioner of claim 17, wherein the water level sensor is configured to rotate about the rotation center by gravity to thereby face the one of the first drain pan or the second drain pan.

20. The air conditioner of claim 15, further comprising:
a bracket coupled to at least one of the first drain pan or the second drain pan; and
a rotating member rotatably coupled to the bracket,
wherein the water level sensor is coupled to the rotating member.

21. The air conditioner of claim 20, wherein the rotating member comprises:
a boss that defines a hollow space therein;
a rotating shaft inserted to the bracket and the hollow space in the boss; and
a coupling section connected to the water level sensor.

22. The air conditioner of claim 21, wherein the rotating member further comprises:
a protrusion that protrudes from an outer circumference of the boss; and
a pin that protrudes from the protrusion toward the bracket, and
wherein the bracket comprises:
a beam coupled to the rotating member, the rotating shaft passing through the beam,
a first restricting projection that protrudes from the beam and is configured to, based on the water level sensor facing the first drain pan, restrict movement of the pin to thereby restrict rotation of the rotating member in a first rotation direction from the first drain pan to the second drain pan, and
a second restricting projection that protrudes from the beam and is configured to, based on the water level sensor facing the second drain pan, restrict movement of the pin to thereby restrict rotation of the rotating member in a second rotation direction from the second drain pan to the first drain pan.

23. The air conditioner of claim 21, wherein the bracket further comprises:
a first stopper and a second stopper that extend from the bracket in a direction parallel to the rotating shaft,
wherein the rotating member further comprises a connector that extends from the boss in a direction perpendicular to the rotating shaft and that is connected to the coupling section, the connector being spaced apart from the bracket,
wherein the first stopper is configured to, based on the connector facing the first drain pan, be disposed at an opposite side of the second drain pan with respect to the connector, and
wherein the second stopper is configured to, based on the connector facing the second drain pan, be disposed at an opposite side of the first drain pan with respect to the connector.

24. The air conditioner of claim 23, wherein a distance between the connector and the bracket is less than a length of each of the first stopper and the second stopper.

25. The air conditioner of claim 15, further comprising a bracket coupled to at least one of the first drain pan or the second drain pan, the bracket comprising a beam that rotatably supports the water level sensor.

26. The air conditioner of claim 25, wherein the bracket further comprises:
a frame disposed parallel to one of the first drain pan or the second drain pan and coupled to the one of the first drain pan or the second drain pan, and
wherein the beam extends from the frame in a direction parallel to the other of the first drain pan or the second drain pan.

27. The air conditioner of claim 26, wherein the first drain pan comprises:
a first base plate that defines the inlet opening;
an inner rim that is bent from a circumference of the inlet opening toward the heat exchanger; and
an outer rim that is bent from an outer circumference of the first base plate toward the heat exchanger.

28. The air conditioner of claim 15, further comprising:
a controller configured to regulate a flow of the refrigerant,
wherein the controller is configured to stop the flow of the refrigerant based on the water level detected by the water level sensor being greater than a reference water level.

29. An air conditioner comprising:
an intake duct configured to receive air from an indoor area;
an indoor unit disposed outside the indoor area and configured to exchange heat between the air received through the intake duct and refrigerant, the indoor unit being further configured to discharge heat-exchanged air having exchanged heat with the refrigerant;
an exhaust duct configured to guide the heat-exchanged air from the indoor unit to the indoor area; and
a controller configured to control operation of the indoor unit,
wherein the indoor unit comprises:
a fan configured to blow the air received from the intake duct toward the exhaust duct,
a heat exchanger configured to exchange heat between the air blown by the fan and the refrigerant,
at least one drain pan configured to receive condensate water generated from the heat exchanger, and
a water level sensor configured to detect a water level in the at least one drain pan, and
wherein the controller is configured to stop operation of the indoor unit based on the water level detected by the water level sensor being greater than a reference water level.

30. The air conditioner of claim 29, wherein the at least one drain pan comprises:
a first drain pan that extends in a direction perpendicular to a blowing direction of the air from the fan toward the heat exchanger; and
a second drain pan that extends in the blowing direction, and
wherein the water level sensor is configured to rotate about a rotating center that is spaced apart from the first drain pan and the second drain pan, the water level sensor being configured to detect the water level of water in one of the first drain pan or the second drain pan.

31. The air conditioner of claim 30, wherein the indoor unit is configured to be installed in a plurality of installation positions relative to a ground surface, and
wherein one of the first drain pan or the second drain pan is configured to face the ground surface based on the indoor unit being installed in one of the plurality of installation positions.

32. The air conditioner of claim 30, wherein the water level sensor is configured to, based on an installation position of the indoor unit relative to a ground surface, rotate about the rotation center by gravity to thereby face one of the first drain pan or the second drain pan.

33. The air conditioner of claim 30, further comprising:
a bracket coupled to at least one of the first drain pan or the second drain pan; and
a rotating member rotatably coupled to the bracket,
wherein the water level sensor is coupled to the rotating member.

34. The air conditioner of claim 33, wherein the rotating member comprises:
a boss that defines a hollow space therein;
a rotating shaft inserted to the bracket and the hollow space in the boss; and
a coupling section connected to the water level sensor.
